(19) United States
(12) Patent Application Publication
(10) Pub. No.: US 2017/0359146 A1
(43) Pub. Date: Dec. 14, 2017

(54) ENHANCED LVA DECODING USING ITERATIVE COMPARISON TRELLIS CONSTRUCTION

(71) Applicant: QUALCOMM Incorporated, San Diego, CA (US)

(72) Inventors: Yang Yang, San Diego, CA (US); Jing Jiang, San Diego, CA (US); Jamie Menjay Lin, San Diego, CA (US); Hari Sankar, San Diego, CA (US); Joseph Binamira Soriaga, San Diego, CA (US)

(21) Appl. No.: 15/592,519

(22) Filed: May 11, 2017

Related U.S. Application Data
(60) Provisional application No. 62/349,553, filed on Jun. 13, 2016.

(51) Int. Cl. H04L 1/00

(52) U.S. Cl. CPC H04L 1/0054; H04L 1/005

(57) ABSTRACT

The described techniques relate to improved methods, systems, devices, or apparatuses that support enhanced efficiency in list Viterbi algorithm (LVA) decoding using iterative comparison trellis construction. Iterative comparison may involve comparison and selection from ordered accumulated path metrics associated with feeding transitions by selecting, for each successive rank of an ordered path metrics list for the current stage, the best unselected accumulated path metric of the feeding transitions. The iterative comparison may be performed sequentially for each stage before processing the next stage. Alternatively, the iterative comparison may be pipelined across stages, and different ranks of the ordered path metrics lists for different stages may be concurrently computed in a single trellis search cycle using multiple comparators. Iterative comparison may be used in an inner decoder to generate an ordered path metrics list for processing according to an error checking function using an outer decoder.

### CROSS REFERENCES

The present application for patent claims priority to U.S. Provisional Patent Application No. 62/349,553 by Yang, et al., entitled “Enhanced LVA Decoding Using Iterative Comparison Trellis Construction,” filed Jun. 13, 2016, and assigned to the assignee hereof, the entirety of which is incorporated by reference herein for any and all purposes.

### BACKGROUND

### Field of the Disclosure

The present disclosure, for example, relates to communication systems, and more particularly to list Viterbi decoding of encoded data sent over a communications channel.

### Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink channels (e.g., for transmissions from a base station to a UE) and uplink channels (e.g., for transmissions from a UE to a base station).

Convolutional codes (CC) are used in communications systems to correct for errors in received signals. A terminated CC starts and ends at a known state. While terminated CCs have the benefit of starting and ending at the same known state (e.g., state 0), they also require extra bits to be added, thereby reducing the effective data rate. Tail biting CCs (TBCC) are a type of CC created by cyclic shifting the last few information bits (tail bits) in a CC to the beginning. Accordingly, the TBCC starts and ends at the same state (determined by these tail bits) without the impact to data rates of terminated CCs. The Viterbi algorithm (VA), which finds the most likely code word (path), may be used for decoding code words encoded with a terminated CC or TBCC. The list Viterbi algorithm (LVA) further reduces the code word error rate by generating a list of the most likely paths, which are then tested in sequence against an error checking function to select the most likely candidate satisfying the error checking function.

To traverse the stages of a code word and maintain a list of the L best candidate paths for each of K states, each stage finds the best L out of T·L candidates, where T is the number of feeding transitions to the state for the stage. As L and/or K increases, performing the comparisons to select the best candidates can be computationally intensive.

### SUMMARY

The described techniques relate to improved methods, systems, devices, or apparatuses that support enhanced efficiency in list Viterbi algorithm (LVA) decoding using iterative comparison trellis construction. Iterative comparison may involve comparison and selection from ordered accumulated path metrics associated with feeding transitions by selecting, for each successive rank of an ordered path metrics list for the current stage, the best unselected accumulated path metric of the feeding transitions. In some examples, the iterative comparison is performed sequentially for each stage before processing the next stage. Sequential comparisons may be performed by using a single comparator (or a single comparator per state) for performing sequential comparisons over multiple cycles. Alternatively, the iterative comparison may be pipelined across stages, and different ranks of the ordered path metrics lists for different stages may be concurrently computed in a single trellis search cycle using multiple comparators (e.g., per state). Iterative comparison may be used in an inner decoder to generate an ordered path metrics list for processing according to an error checking function using an outer decoder.

A method of wireless communication is described. The method may include identifying branch metrics associated with N stages for an encoded data block received over a communication channel, generating a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states, and selecting output bits corresponding to one of the plurality of candidate paths for the data block by applying an error checking function to one or more of an ordered list of the plurality of candidate paths and selecting a first candidate path that satisfies the error checking function.

Another apparatus for wireless communication is described. The apparatus may include a processor, memory in electronic communication with the processor, and instructions stored in the memory. The instructions may be operable to cause the processor to identify branch metrics associated with N stages for an encoded data block received over a communication channel, generate a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states, and select output bits corresponding to one of the plurality of candidate paths for the data block by applying an error checking function to one or more of an ordered list of the plurality of candidate paths and selecting a first candidate path that satisfies the error checking function.

A non-transitory computer readable medium for wireless communication is described. The non-transitory computer-readable medium may include instructions operable to cause a processor to identify branch metrics associated with N stages for an encoded data block received over a communication channel, generate a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states, and select output bits corresponding to one of the plurality of candidate paths for the data block by applying an error checking function to one or more of an ordered list of the plurality of candidate paths and selecting a first candidate path that satisfies the error checking function.

In some examples of the method, apparatus, and non-transitory computer-readable medium described above, the generating comprises ordering the respective path metrics lists for the plurality of states for each of the N stages based on an iterative comparison, over the L candidate paths, of highest ranked unselected metrics of the accumulated path metrics for the each of the N stages.

In some examples of the method, apparatus, and non-transitory computer-readable medium described above, ordering the respective path metrics lists for the plurality of states for each of the N stages based on the iterative comparison comprises: comparing highest ranked unselected accumulated path metrics associated with respective feeding transitions to each of the plurality of states. Some examples of the method, apparatus, and non-transitory computer-readable medium described above may further include processes, features, means, or instructions for selecting a next rank of the ordered path metrics list based on the comparison. Some examples of the method, apparatus, and non-transitory computer-readable medium described above may further include processes, features, means, or instructions for iteratively performing the comparing and selecting over the L candidate paths.

In some examples of the method, apparatus, and non-transitory computer-readable medium described above, the concurrently computing comprises selecting, for each of the plurality of states, a first rank of the ordered path metrics list for a stage (n) of the N stages based on comparing highest ranked accumulated path metrics associated with the respective feeding transitions of a stage (n−1) and a second rank of the ordered path metrics list for the stage (n−1) of the N stages based on comparing highest ranked unselected accumulated path metrics for a stage (n−2).

In some examples of the method, apparatus, and non-transitory computer-readable medium described above, the concurrently computing comprises selecting, for each of the plurality of states, an Lth rank of the ordered path metrics list for a stage (n−(L−1)) of the N stages based on comparing highest ranked unselected accumulated path metrics for a stage (n−L). In some examples of the method, apparatus, and non-transitory computer-readable medium described above, the concurrently computing, for each of the plurality of pipelined trellis search cycles, may be performed with a plurality of comparators for each of the plurality of states.

In some examples of the method, apparatus, and non-transitory computer-readable medium described above, the plurality of comparators includes L comparators for each of the plurality of states. In some examples of the method, apparatus, and non-transitory computer-readable medium described above, the generating comprises sequentially computing, for each stage of the N stages, the ordered path metrics list for each of the plurality of states.

In some examples of the method, apparatus, and non-transitory computer-readable medium described above, the comparisons for the sequential computing for each of the plurality of states may be performed with a single comparator. In some examples of the method, apparatus, and non-transitory computer-readable medium described above, the encoded data block may be encoded according to a convolutional code.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system;

FIG. 2 illustrates an example of a wireless communications system supporting enhanced efficiency decoding using iterative comparison trellis construction;

FIG. 3 illustrates an example of a trellis diagram for a 4-state encoder;

FIG. 4 illustrates an example representation of surviving paths through a trellis for list Viterbi algorithm (LVA) decoding;

FIG. 5 illustrates an example of a trellis diagram depicting a path having known starting and terminating states for LVA decoding;

FIGS. 6A-6D show diagrams of a simplified example of trellis construction for list Viterbi decoding using iterative comparison;

FIGS. 7A-7F show diagrams of a simplified example of trellis construction for list Viterbi decoding using pipelined iterative comparison;

FIG. 8 shows a block diagram of a wireless device that supports enhanced LVA decoding using iterative path selection;

FIGS. 9A and 9B show block diagrams of decoders that supports enhanced LVA decoding using iterative path selection;

FIG. 10 shows a block diagram of a parallel comparison processor that supports enhanced LVA decoding using pipelined iterative path selection;

FIG. 11 shows a diagram of a system including a device that supports enhanced LVA decoding using iterative path selection;

FIG. 12 shows a diagram of a system including a device that supports enhanced LVA decoding using iterative path selection; and

FIG. 13 shows a flowchart illustrating a method for enhanced LVA decoding using iterative path selection.

### DETAILED DESCRIPTION

The described aspects relate to enhanced efficiency in list Viterbi algorithm (LVA) decoding using iterative comparison trellis construction. Iterative comparison may be used in an inner decoder to generate an ordered path metrics list for processing according to an error checking function using an outer decoder. Iterative comparison may involve comparison and selection from ordered accumulated path metrics associated with feeding transitions by selecting, for each successive rank of an ordered path metrics list for the current stage, the best unselected accumulated path metric of the feeding transitions. In some examples, the iterative comparison is performed sequentially for each stage before processing the next stage. Sequential comparisons may be performed by using a single comparator (or a single comparator per state) for performing sequential comparisons over multiple cycles. Alternatively, the iterative comparison may be pipelined across stages, and different ranks of the ordered path metrics lists for different stages may be concurrently computed in a single trellis search cycle using multiple comparators (e.g., per state). The number of comparators may be traded off with the number of cycles for performing the pipelined comparisons. The described techniques may reduce computational complexity and/or latency for LVA decoding in a communications system. Although generally described in the context of a wireless communications system, the techniques may be applied to decoding of communications received over wired communication channels.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

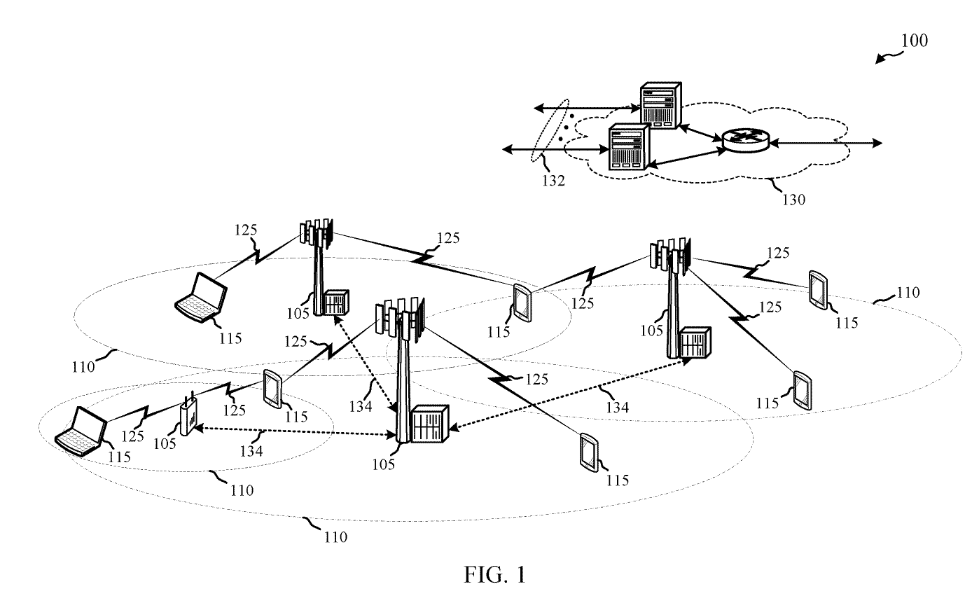

FIG. 1 illustrates an example of a wireless communications system 200 in accordance with various aspects of the disclosure. The wireless communications system 100 includes base stations 105, user equipments (UEs) 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is an LTE/LTE-A network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station 105, a carrier or component carrier associated with a base station 105, or a coverage area (e.g., sector, etc.) of a carrier or base station 105, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels. Downlink physical channels may include a physical broadcast channel (PBCH) for broadcast information, physical control format indicator channel (PCFICH) for control format information, physical downlink control channel (PDCCH) for control and scheduling information, physical hybrid ARQ indicator channel (PHICH) for HARQ status messages, physical downlink shared channel (PDSCH) for user data and physical multicast (PMCH) for multicast data. Uplink physical channels may include physical random access channel (PRACH) for access messages, physical uplink control channel (PUCCH) for control data, and physical uplink shared channel (PUSCH) for user data.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier, a layer, a channel, etc. The terms “carrier,” “component carrier,” “cell,” and “channel” may be used interchangeably herein. A UE 115 may be configured with multiple downlink component carriers and one or more uplink component carriers for carrier aggregation. Carrier aggregation may be used with both FDD and TDD component carriers.

The wireless communication system 100 may support forward error correction (FEC) for use in improving throughput and reliability in channels with varying signal-to-noise ratio (SNR). Types of codes used in FEC include convolutional codes, turbo codes, low-density parity check (LDPC) codes, and the like. Generally, the decoder attempts to select a code word with a maximum likelihood of being the code word that was sent, based on the received symbol information and properties of code words inherent to the encoding scheme. One form of maximum likelihood decoding is Viterbi decoding, which finds the most likely sequence of states given branch metrics associated with state transitions between path nodes. In some cases, an LVA may be used to generate a list of candidate sequences of states for input to an outer decoder. The outer decoder may perform error checking on the list of candidate sequences, starting from the candidate having the best overall path metric. The first candidate sequence that passes the error checking may be used to output the decoded bit stream. The error checking decoder may perform, for example, a cyclic redundancy check (CRC) on the list of candidate sequences.

With a list size of L, the LVA may be understood as constructing a trellis over N path nodes, where a list of L candidates is determined for each state of each path node using path metrics from the previous path node and branch metrics associated with the feeding transitions from the feeding states of the previous path node. The feeding transitions for each state of a path node may thus be understood as associated with T·L accumulated path metrics corresponding to each of T feeding states. Selection of the L best accumulated path metrics may be performed by sorting the T·L accumulated path metrics and taking the best L accumulated path metrics as the path metrics for the current path node. However, direct sorting is computationally intensive, generally taking L·log(T·L) cycles per path node, with L·log(T·L)·K total comparisons per path node for a trellis with K states. Thus, improvements in trellis construction for LVA may improve power consumption and decrease latency in decoding operations for communication devices.

According to various aspects of the disclosure, the devices of wireless communication system 100 including bases stations 105 or UEs 115 may be configured for enhanced efficiency in LVA decoding using iterative comparison trellis construction. Iterative comparison may involve comparison and selection from ordered accumulated path metrics associated with feeding transitions by selecting, for each successive rank of an ordered path metrics list for the current stage, the best unselected accumulated path metric of the feeding transitions. In some examples, the iterative comparison is performed sequentially for each stage before processing the next stage. Sequential comparisons may be performed by using a single comparator (per state) for performing sequential comparisons in multiple cycles. Alternatively, the iterative comparison may be pipelined across stages, and different ranks of the ordered path metrics lists for different stages may be concurrently computed in a single trellis search cycle using multiple comparators. The number of comparators may be traded off with the number of cycles for performing the pipelined comparisons.

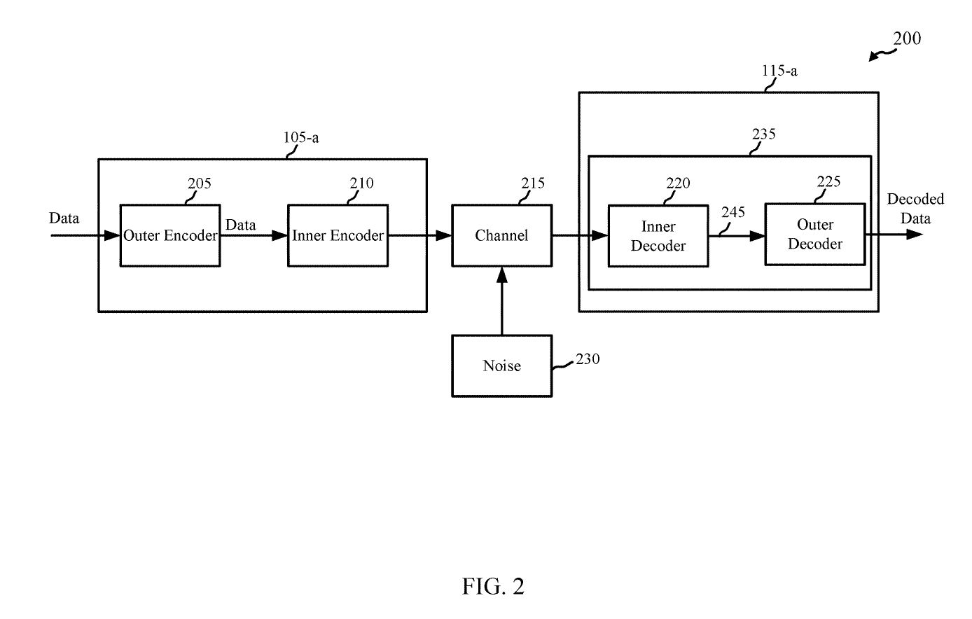

FIG. 2 illustrates an example of a wireless communications system 200 supporting enhanced efficiency decoding using iterative comparison trellis construction in accordance with various aspects of the disclosure. The wireless communications system 200 may include a source device that generates, encodes, and transmits data to a receiving device via a communication channel. In the depicted example, base station 105-a may be the source device and UE 115-a may be the receiving device. However, devices other than UE 115-a and base station 105-a may transmit and receive encoded data according to the techniques described herein. The following discusses decoding of encoded data received over a communication channel using the LVA. Algorithms other than LVA may be used.

In the downlink direction, the base station 105-a may output data for transmission to the UE 115-a. The data may be, for example, a single code word or multiple code words. In the depicted example, the base station 105-a may include an outer encoder 205 and an inner encoder 210. The base station 105-a first applies an outer code to the data to be transmitted, followed by an inner code. In an example, the outer code may be an error detecting code (e.g., CRC, etc.) and the inner code may be a convolutional code. The outer encoder 205 and/or inner encoder 210 may introduce redundancy during encoding to permit FEC to account for noise 230 occurring in a communication channel 215 (e.g., a wired or wireless channel). A convolutional code may be used, for example, in encoding downlink control information (DCI) in the PDCCH.

The inner encoder 210 may be a convolutional encoder or trellis encoder. The inner encoder 210 may apply any convolutional-based coding scheme, such as, for example, a convolutional code (CC), terminated CC, tail-biting CC (TBCC), and the like. The inner encoder 205 proceeds through a sequence of states as it accepts data bits from the outer encoder 205 and produces output that subsequently is used to define an output sequence of symbols that is transmitted over the communication channel 215 (which may be noisy or otherwise impaired). The output sequence of symbols corresponds to a path through a trellis.

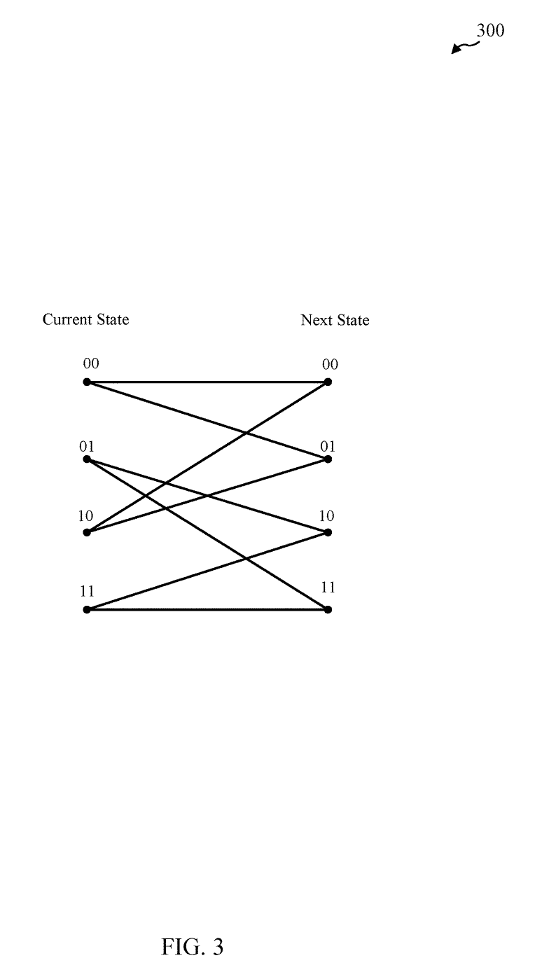

A convolutional encoder may be viewed as a finite-state machine that operates serially on a sequence of information bits. FIG. 3 illustrates an example of a trellis diagram 300 for a 4-state encoder. The trellis diagram 300 indicates, for each encoder state, to which next state or states the encoder is allowed to transition. The four states of the encoder are denoted by nodes labeled 00, 01, 10, and 11. The two vertical lines of points in FIG. 3 respectively represent the possible current and next stage of encoder states. The lines connecting the various pairs of states indicate allowed state transitions. For example, the inner encoder 210 can transition from current state 00 to either next state 00 or 01 but not to states 10 or 11. The inner encoder 210 transitions from one state to another in response to input information bits, the transition being indicated by a branch in the trellis diagram 300. Although trellis diagram 300 shows an encoding of two bits per stage (e.g., four states), more bits may be encoded per stage, corresponding to higher numbers of states (e.g., 8 states, 16 states, etc.).

Referring again to FIG. 2, after transmission of the encoded data over the communication channel 215, the UE 115-a may receive and demodulate the encoded data and forward to a decoder 235 for decoding. For example, the UE 115-a may perform down-conversion, baseband processing (e.g., filtering, etc.), and analog-to-digital (A/D) conversion on signals received over the communication channel 215. Decoder 235 may generate branch metrics based on the digital samples and knowledge of the code used by the inner encoder 210 (e.g., allowed path transitions for a convolutional encoding algorithm).

Decoder 235 may include an inner decoder 220 and an outer decoder 225. In an example, the inner decoder 220 may apply the LVA to decode the data based on the branch metrics. List Viterbi algorithms are particularly effective in performing error detection/correction for convolutionally encoded data. The inner decoder 220 determines the path with the best path metric using maximum likelihood decoding. The path through the trellis having the best path metric may correspond to the most likely sequence of symbols that was transmitted. Whereas a conventional Viterbi algorithm identifies a single best path through the trellis, a List Viterbi algorithm identifies the L best paths, or L best possible outcomes, through the trellis.

The Viterbi algorithm, including the List Viterbi algorithm, works for any path metric, whether or not the path metric corresponds to maximum likelihood decoding. For example, the path metric may also be a log likelihood metric, the log a posteriori metric, the Hamming metric, any combination thereof, or the like.

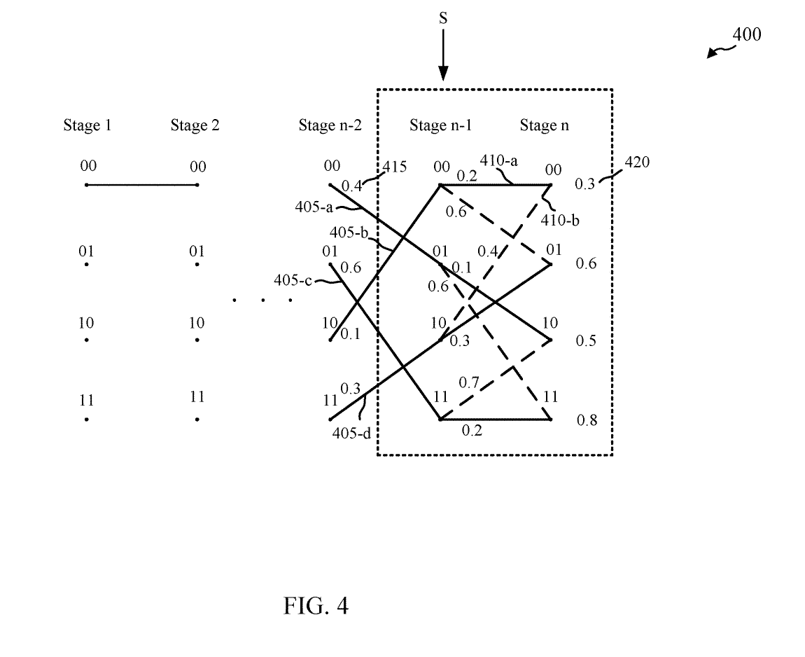

The inner decoder 220 operates by determining the paths with the best path metrics leading into each state of the code at any point in time. FIG. 4 illustrates an example representation 400 of surviving paths through a trellis for LVA decoding. Operation of the inner decoder 220 for the 4-state convolutional code shown in FIG. 3 is illustrated in FIG. 4. Only surviving paths are considered as candidate paths for the best path through the trellis.

As shown in FIG. 4, at stage n−1, inner decoder 220 receives a channel-corrupted symbol S and proceeds to extend the four current surviving paths (labeled 405-a through 405-d) through the trellis and to update their path metrics. The current path metrics for surviving paths 405-a through 405-d are 0.4, 0.6, 0.1 and 0.3, respectively, with lower metrics being better. As also shown, the inner decoder 220 computes branch metrics for each branch of the trellis. For example, branch metric 415 has a value of 0.4. For each next state of the code, the inner decoder 220 compares the path metrics of the two extended surviving paths entering that state. In the case of next state 00, those paths metrics are (0.1+0.2=0.3) and (0.3+0.4=) 0.7. The path with the best path metric, in this case the extension of path 405-c through next state 00 having a path metric of 0.3 (see element 420), is retained as a new surviving path. The other extended paths that are retained as new surviving paths are indicated in FIG. 4 by solid lines (see, e.g., 410-a), these having path metrics of (0.3+0.3=0.6); (0.4+0.1=) 0.5; and (0.6+0.2=) 0.8, respectively. The extended paths that are “pruned” or discarded have their last constituent branch indicated by dashed lines (see, e.g., 410-b).

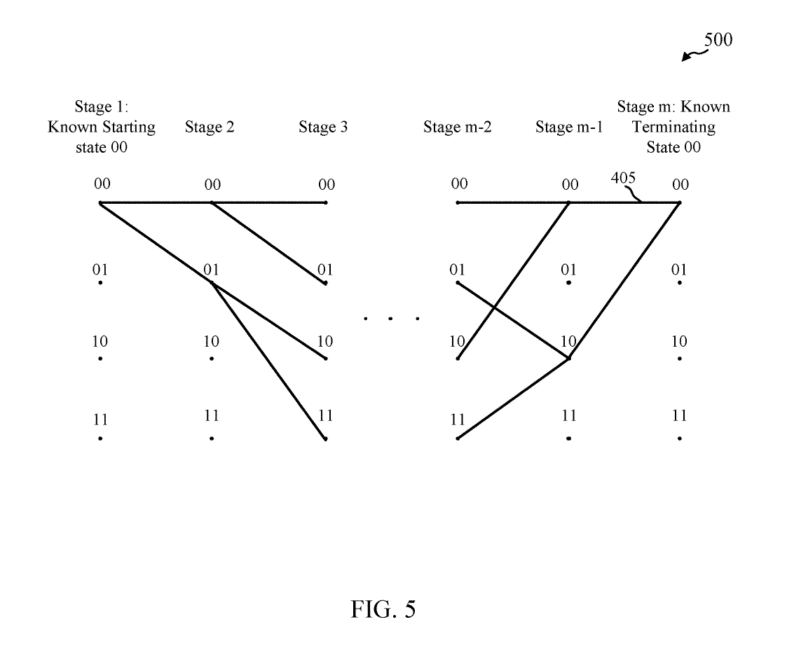

There are several ways in which decisions may be made by the inner decoder 220. If the inner decoder 220 knows the number of transmitted symbols and the encoder starting state, the inner decoder 220 may withhold making any decisions until all symbols are processed. At that time, the inner decoder 220 will have completed its forward processing through the trellis and will be ready to make a decision as to the best path. Only paths which begin with the known starting state can be regarded as surviving paths and the surviving path having the best path metric is typically selected as the best path. If the inner decoder 220 further knows the identity of the encoder termination state (e.g., a tail was appended to the data), the surviving path with the best path metric that enters that known termination state is determined to be the best path. This scenario is illustrated in FIG. 5. FIG. 5 illustrates an example of a trellis diagram 500 depicting a path having known starting and terminating states for LVA decoding. As shown, both the starting and terminating states are state 00.

The inner decoder 220 then determines the sequence of symbols in L best paths as its best estimates of the transmitted symbols. The inner decoder 220 produces a rank ordered list of the L best possible decoding solutions (e.g., L best candidates) corresponding to a block of convolutionally coded data (typically in terms of path metrics). That is, an LVA finds the L best output sequences of a certain length, e.g., the length of the corresponding data block. The inner decoder 220 provides the L best decoded sequences 245 to the outer decoder 225 in a rank order list that is ranked based on their respective path metrics.

The outer decoder 225 applies an error detection algorithm to the best of the L decoded sequences (e.g., a CRC check). If the best of the L decoded sequences passes the error detection algorithm, the outer decoder 225 concludes that the passing sequence was the transmitted data. If an error is detected in the best decoded sequence, the outer decoder 225 applies the error detection algorithm to the second best of the L decoded sequences. If the second best sequence has an error, the third best is tried, and so forth until one of the L decoded sequences satisfies the error detection algorithm or all or the L decoded sequences are found to have an error.

Inner decoder 220 may use iterative comparison for generating a trellis, which may then be backtracked to determine the L best paths. Iterative comparison may be performed by, for each state for each stage, comparing the best accumulated path metrics (e.g., the best path metrics from the prior stage for feeding transitions with the branch metrics for the feeding transitions added) and selecting the best accumulated path metric as the best new path metric for the stage. Then, the unselected best accumulated path metric (from the unselected feeding transition) is compared against the next best accumulated path metric, with again the best of the compared accumulated path metrics selected as the next new path metric. The comparison and selection is performed until an ordered list of L path metrics has been selected for the state for the stage. Each state of each stage thus maintains an ordered list (selected from prior ordered lists), enabling the iterative selection to work for the next stage. Iterative comparison is more computationally efficient than direct sorting of accumulated stage metrics, generally taking L cycles per stage, with L·K total comparisons per stage for a trellis with K states.

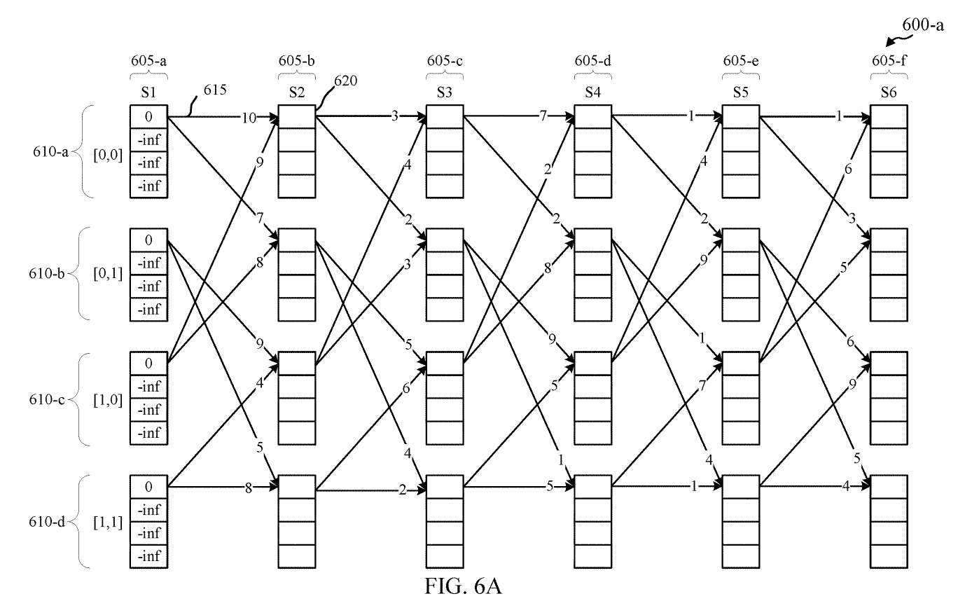

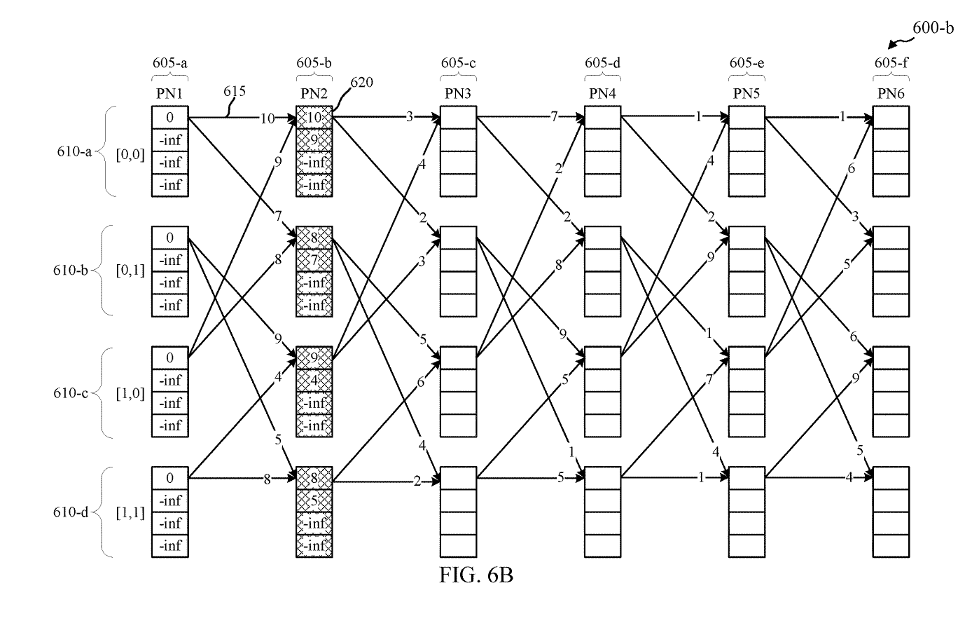

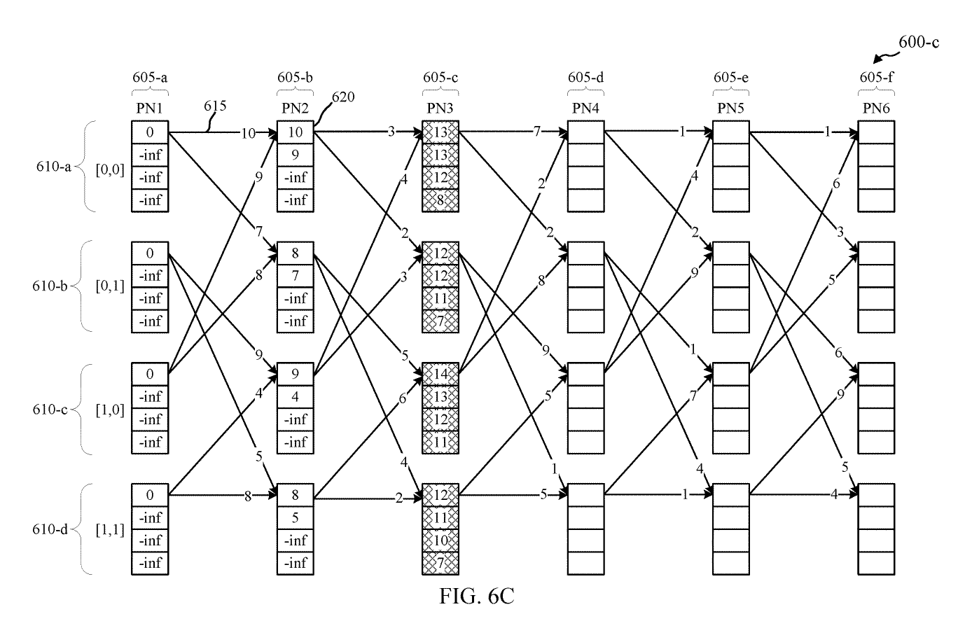

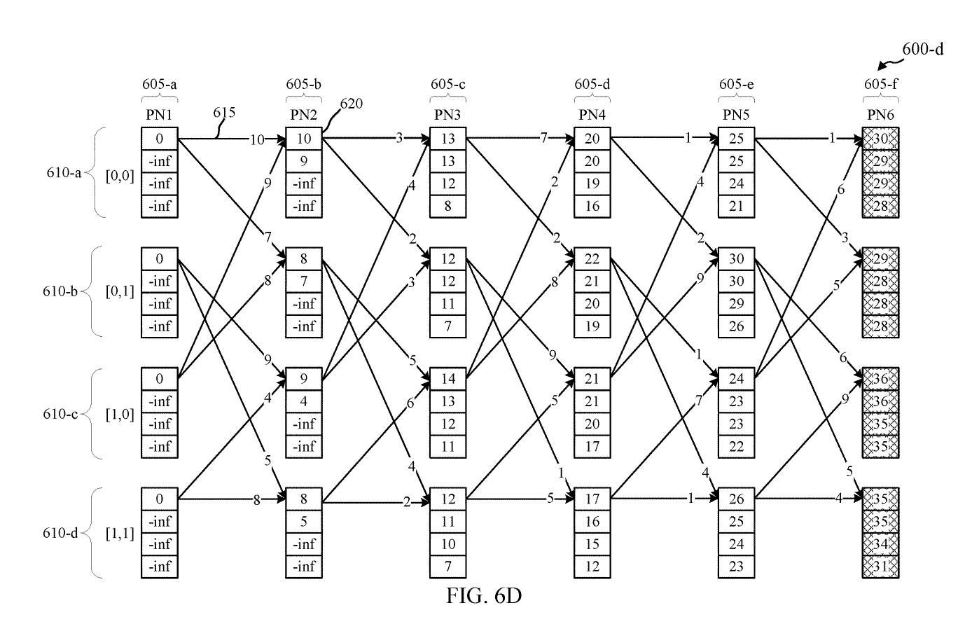

FIGS. 6A-6D show diagrams of a simplified example of trellis construction for list Viterbi decoding using iterative comparison, in accordance with various aspects of the disclosure. In the example shown in FIGS. 6A-6D, the trellis is constructed for trellis stages S1 605-a, S2 605-b, S3 605-c, S4 605-d, S5 605-e, and S6 605-f using branch metrics 615 (only one being labeled for clarity), which may be determined from digital samples of a signal received over a communication channel (e.g., communication channel 215 of FIG. 2). In the example of FIGS. 6A-6D, the trellis is constructed with a list size of four (L=4) over four possible states for each transition (e.g., state 610-a corresponding to [0,0], state 610-b corresponding to [0,1], state 610-c corresponding to [1,0], and state 610-d corresponding to [1,1]). In the example of FIGS. 6A-6D, higher branch metrics are correlated with higher probability of being a correct transition (and therefore higher path metrics are better).

In FIG. 6A, ordered path metrics lists 620 (only one of which has been labeled for clarity) have been initialized for stage S1 605-a, while all other ordered path metrics lists 620 have not been determined. FIG. 6B shows a diagram 600-b of calculation of ordered path metrics lists 620 for stage S2 605-b. Ordered path metrics lists 620 may be computed, for each stage 605, using iterative comparison of accumulated path metrics feeding into each of the states 610. Accumulated path metrics may be computed by adding the path metrics from feeding states of a previous stage and the branch metrics associated with the respective feeding transitions. For example, path metrics 620 for state 610-a in stage 605-b may be computed based on iterative comparison of accumulated path metrics for transitions from state 610-a and 610-c of stage 605-a. The iterative comparison may first compare the highest accumulated path metric for the transition from state 605-a to the highest accumulated path metric for the transition from state 605-c. In this case, the highest path metrics for state 605-a are initialized to zero, with other path metrics undefined or, as indicated in FIGS. 6A-6D, initialized to negative infinity (or some other value that will result in that path metric not propagating into valid paths). The accumulated path metric for the transition from state 610-a of stage 605-a may be selected as the highest ranked path metric for state 610-a for stage 605-b. The second ranked path metric for state 610-a for stage 605-b may be selected by comparing the accumulated path metric associated with the highest rank from state 610-c of stage 605-a with the accumulated path metric associated with the second-highest rank from state 610-a of stage 605-a. Because the second-highest ranked path metric for state 610-a of stage 605-a is negative infinity, the accumulated path metric from state 610-c of stage 605-a is selected as the second ranked path metric for state 610-a for stage 605-b. The remaining ranks for stage 610-a of stage 605-b are selected similarly, using a comparison of the highest unselected accumulated path metrics from each of the feeding transitions. Thus, the iterative comparison for each stage takes L iteration cycles, where each iteration cycle selects the next ranked value for the ordered path metrics list 620 based on comparing the best accumulated path metrics that were not selected in previous iteration cycles. As can be seen, for stage 605-b, the lower two ranks for the list size of L=4 are filled with negative infinity. Iterative comparison is also used to fill out the ordered path metrics lists 620 for other states 610 for stage 605-b.

FIG. 6C shows a diagram 600-c of calculation of ordered path metrics lists 620 for stage S2 605-c using iterative comparison of accumulated path metrics feeding into each of the states 610. For example, path metrics 620 for state 610-a in stage 605-c may be computed based on iterative comparison of accumulated path metrics for transitions from state 610-a and 610-c of stage 605-b. The iterative comparison may first compare the highest accumulated path metric for the transition from state 605-a to the highest accumulated path metric for the transition from state 605-c. In this example, the accumulated path metrics for the transitions from stages 610-a and 610-c are equal (13), and therefore one is selected as the highest ranked path metric for state 610-a of stage 605-c. The highest unselected accumulated path metrics are then 13 from state 610-c and 12 from state 610-a. Thus, the accumulated path metric from state 610-c is selected as the second highest path metric for state 610-a of stage 605-c. The iterative comparison and selection of the highest unselected accumulated path metrics from the feeding states is performed L times to select the ordered path metrics list 620 for state 610-a of stage 605-c. Iterative comparison is also used to fill out the ordered path metrics lists 620 for other states 610 for stage 605-c.

The iterative comparison procedure is performed for each stage 605, with diagram 600-d of FIG. 6D showing the trellis constructed through stage 605-f. While diagram 600-d shows an ordered path metrics list for each of the states 610, the L best paths will collapse to being in one ordered path metrics list when the trellis is terminated, as discussed above with reference to FIG. 5. Notably, the ordered path metrics lists 620 for each of the states 605 can be calculated concurrently if separate comparison/selection circuits are included for each state 605. While FIGS. 6A-6D show the best path metrics selected as the highest values of accumulated path metrics, the best paths may be given by the lowest path metrics values, in various examples.

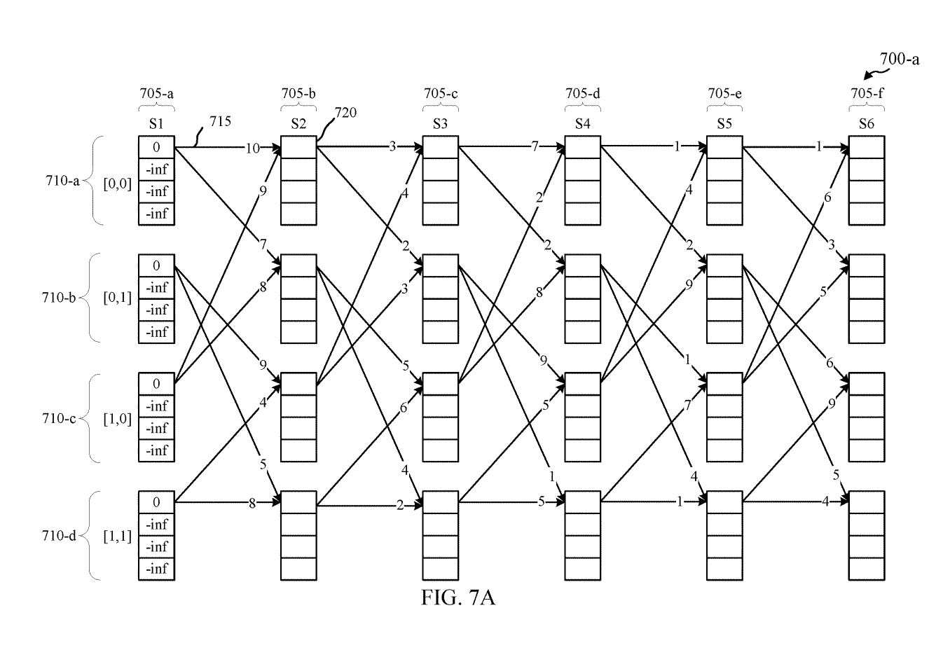

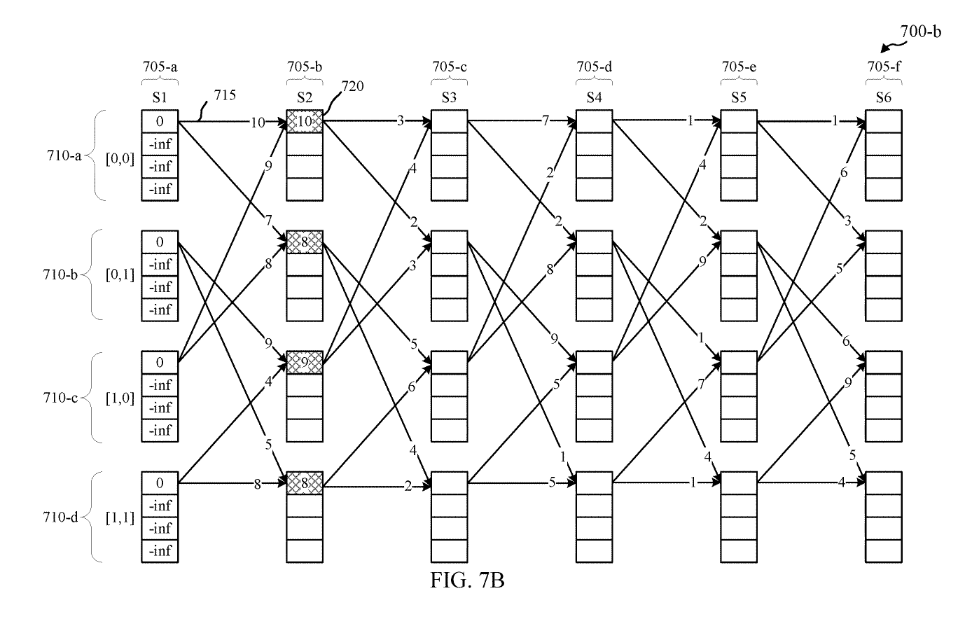

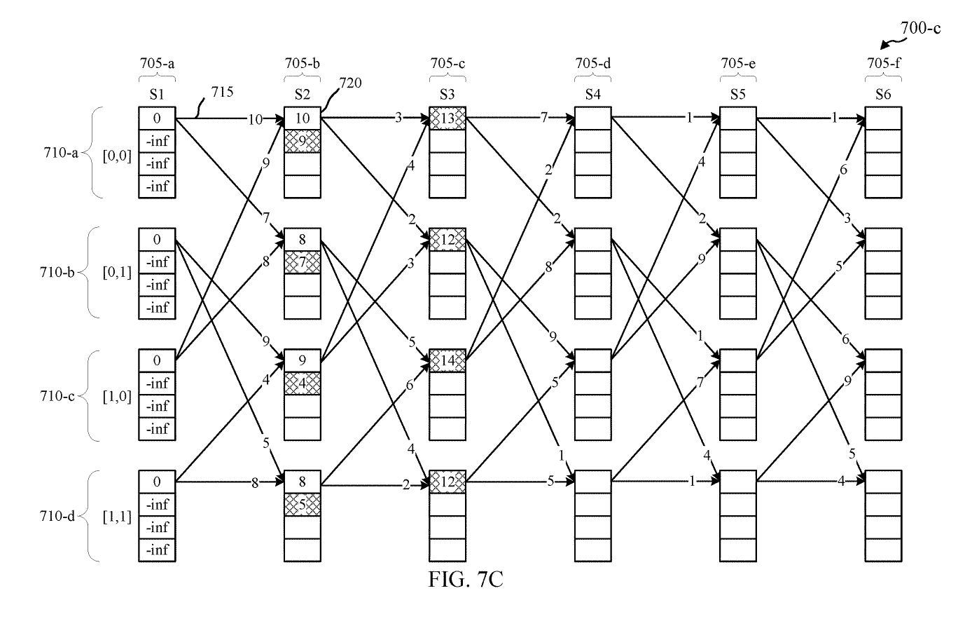

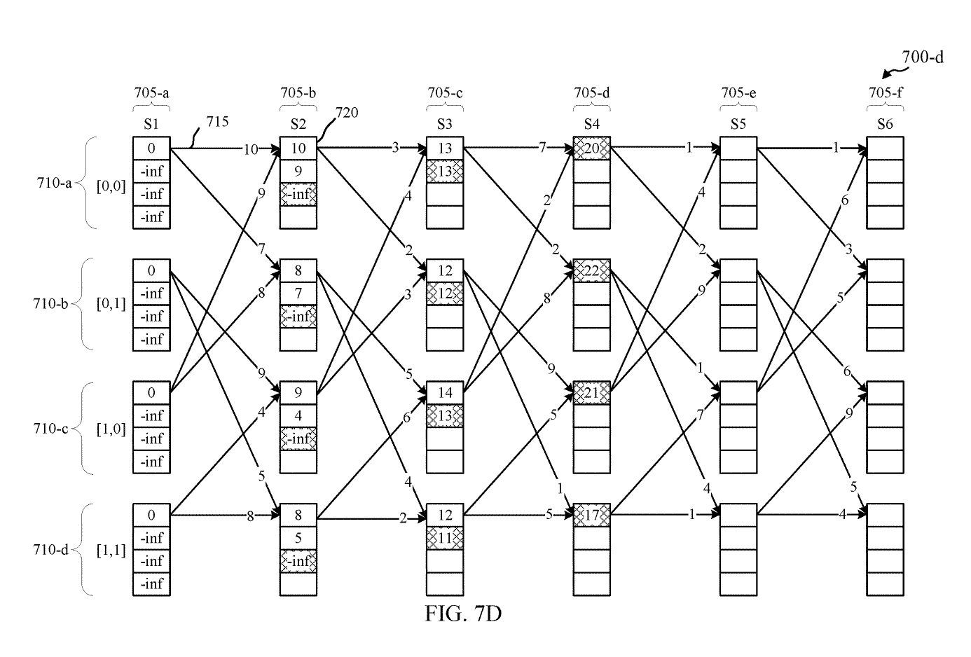

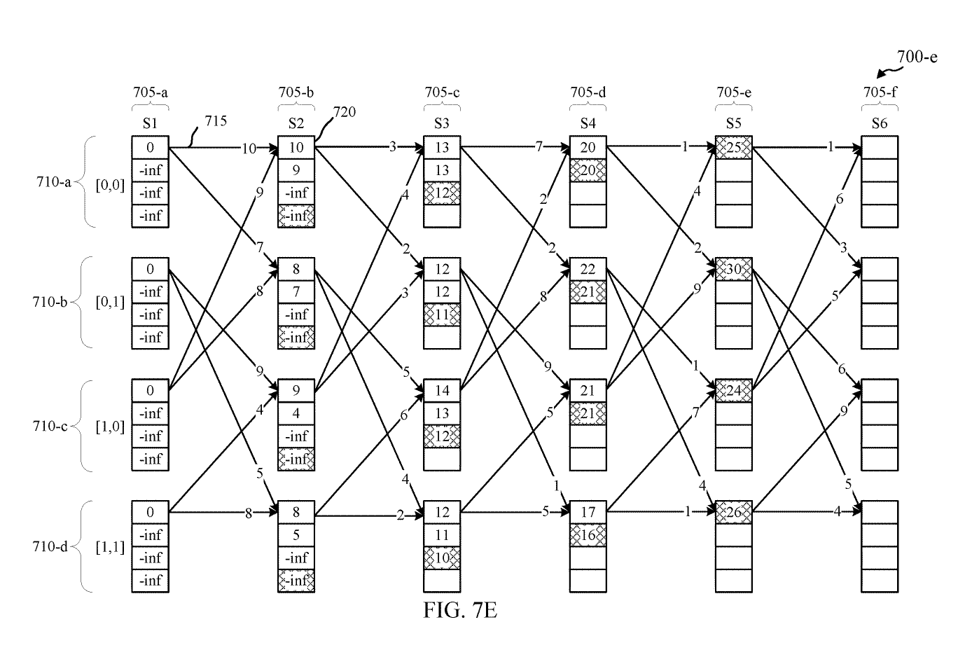

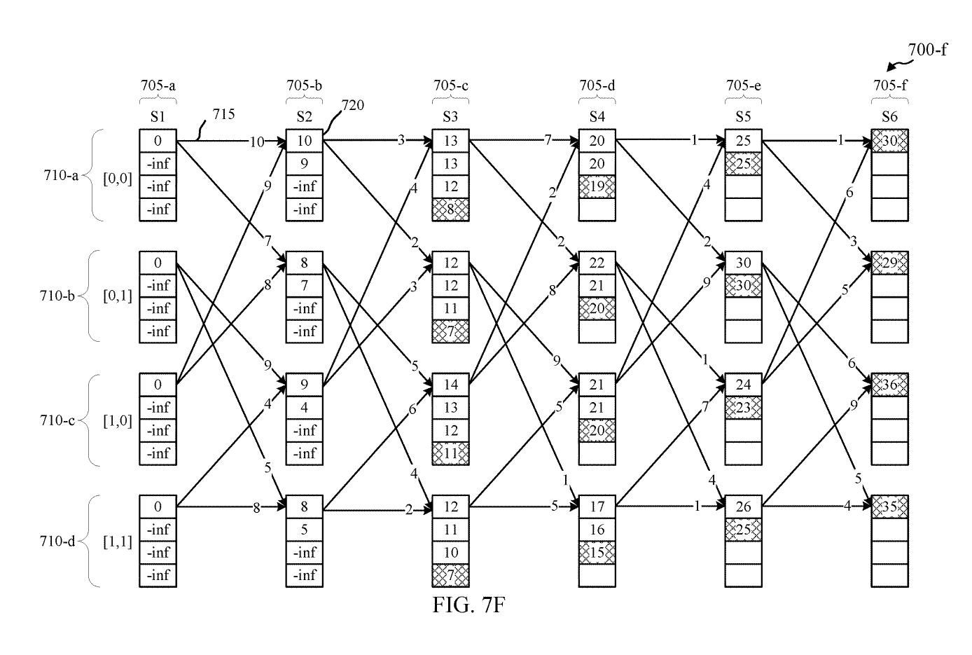

According to various aspects, the inner decoder may employ pipelined iterative decoding for increased efficiency in decoding. FIGS. 7A-7F show diagrams of a simplified example of trellis construction for list Viterbi decoding using pipelined iterative comparison, in accordance with various aspects of the disclosure. In the example shown in FIGS. 7A-7F, the trellis is constructed for trellis stages S1 705-a, S2 705-b, S3 705-c, S4 705-d, S5 705-e, and S6 705-f using branch metrics 715 (only one being labeled for clarity), which may be determined from digital samples of a signal received over a communication channel (e.g., communication channel 215 of FIG. 2). In the example of FIGS. 7A-7F, the trellis is constructed with a list size of four (L=4) over four possible states for each transition (e.g., state 710-a corresponding to [0,0], state 710-b corresponding to [0,1], state 710-c corresponding to [1,0], and state 710-d corresponding to [1,1]).

In diagram 700-a of FIG. 7A, ordered path metrics lists 720 (only one of which has been labeled for clarity) have been initialized for stage S1 705-a, while all other ordered path metrics lists 720 have not been determined. In FIG. 7B, diagram 700-b shows a first pipelined trellis search cycle, with the highest ranked values of the ordered path metrics lists 720 (shown with cross-hatching) selected for stage 705-b based on comparison of the best accumulated path metrics from the feeding transitions from stage 705-a. Diagram 700-c of FIG. 7C shows a second pipelined trellis search cycle, with the highest ranked values of the ordered path metrics lists 720 selected for stage 705-c based on comparison of the best accumulated path metrics from the feeding transitions from stage 705-b. In addition, the second ranked path metrics for stage 705-b are selected from the best unselected accumulated path metrics from feeding transitions from stage 705-a. Notably, selection of the highest ranked path metrics of the ordered path metrics lists 720 for stage 705-c depends only on the highest ranked accumulated path metrics from feeding transitions of for stage 705-b. Thus, selection of the highest ranked path metrics of the ordered path metrics lists 720 for stage 705-c can be performed concurrently with selection of second ranked path metrics for stage 705-b. Thus, these operations can be performed in the same pipelined trellis search cycle.

Diagram 700-d of FIG. 7D shows a third pipelined trellis search cycle, with the highest ranked values of the ordered path metrics lists 720 selected for stage 705-d based on comparison of the best accumulated path metrics from the feeding transitions from stage 705-c. In addition, the second ranked path metrics for stage 705-c and third ranked path metrics for stage 705-b are selected from the best unselected accumulated path metrics from feeding transitions. Again, selection of each of the illustrated path metrics for the third pipelined trellis search cycle are not dependent upon each other, and therefore can be performed concurrently (e.g., in the same comparison cycle by separate hardware/processing components, etc.).

Diagrams 700-e and 700-f of FIGS. 7E and 7F show fourth and fifth pipelined trellis search cycles, with the highest ranked values of the ordered path metrics lists 720 selected for a stage (n) based on comparison of the best accumulated path metrics from the feeding transitions from stage (n−1). In addition, the second ranked value of the ordered path metrics lists 720 for stage (n−1) may be selected based on comparison of the best unselected accumulated path metrics from the feeding transitions from stage (n−2). Lower ranked values for other stages may also be selected concurrently as shown, with the Lth best value for the ordered path metrics lists 720 for a stage (n−(L−1)) selected based on comparison of the best unselected accumulated path metrics from the feeding transitions from stage (n−L). Again, selection of the path metrics across stages for each of the pipelined trellis search cycles are not interdependent and can be performed concurrently.

Selection of each of the L best path metrics may be performed across L stages in one pipelined trellis search cycle. Pipelined iterative comparison thus can perform iterative comparison using only 1 effective cycle per stage, with L·K total comparisons performed concurrently for a trellis with K states in the 1 cycle. Because the number of effective comparison cycles per stage does not depend on the list size L, the time complexity and therefore latency of performing LVA decoding does not depend on the list size.

If the device has fewer than L·K comparators, the pipelined trellis search cycle may be performed in multiple comparison cycles. For example, where a device has (L·K)/2 individual comparators, each pipelined trellis search cycle may take two comparison cycles. Thus, where hardware comparators are used on a decoding circuit, the chip area for the decoders may be traded off with the number of cycles used to perform the comparisons. For example, where the chip area of the decoders may be X for direct sorting or iterative decoding, the chip area of the decoders for pipelined iterative decoding where each pipelined trellis search cycle takes 1 comparison cycle is L·X. Decreasing the chip area by a factor of M (e.g., chip area (L·X)/M) will result in each pipelined trellis search cycle effectively taking M comparison cycles.

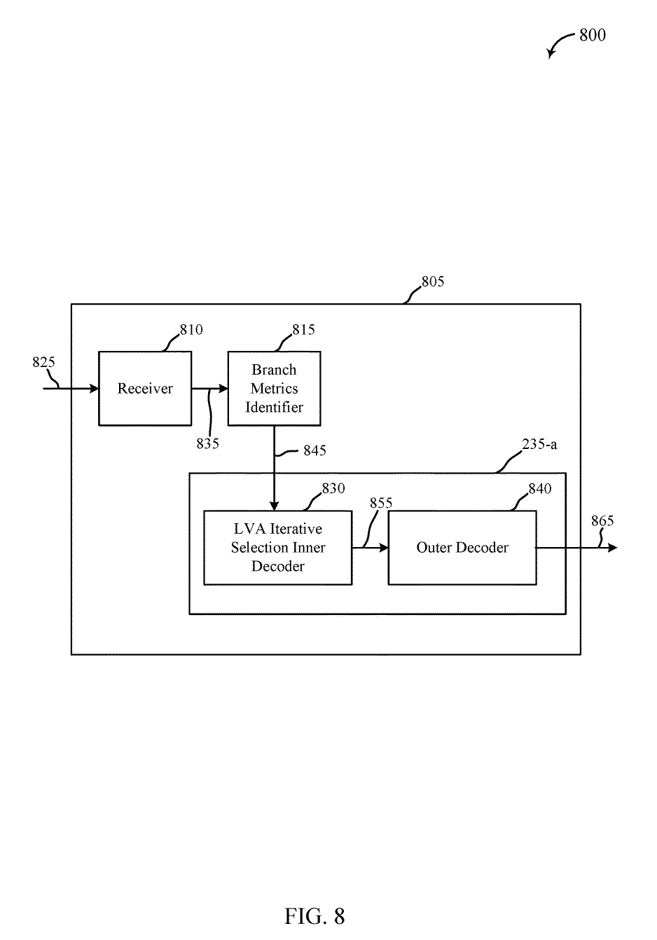

FIG. 8 shows a block diagram 800 of a wireless device 805 that supports enhanced LVA decoding using iterative path selection in accordance with various aspects of the present disclosure. Wireless device 805 may be an example of aspects of a UE 115 or base station 105 as described with reference to FIG. 1. Wireless device 805 may include receiver 810, branch metrics identifier 815, and decoder 235-a. Decoder 235-a may be an example of decoder 235 of FIG. 2. Wireless device 805 may also include a processor. Each of these components may be in communication with one another (e.g., via one or more buses).

Receiver 810 may receive signals 825 (e.g., wireless signals) and generate digital samples 835 for symbols of the received signal. Receiver 810 may perform, for example, down-conversion, baseband processing (e.g., filtering, etc.), and analog-to-digital (A/D) conversion on signals 825. Branch metrics identifier 815 may receive digital samples 835 and generate branch metrics 845 based on the digital samples 835 and path transition information (e.g., allowed path transitions for an encoding algorithm). For example, branch metrics identifier 815 may obtain branch metrics 845 by performing symbol de-mapping for symbols of the received signals 825. Branch metrics 845 may include branch metrics for transitions of a set of states across N stages of a code word.

Decoder 235-a may include LVA iterative selection inner decoder 830 and outer decoder 840. LVA iterative selection inner decoder 830 may receive branch metrics 845 from branch metrics identifier 815, and generate ordered path list 855, which may include, for example, the L best paths determined via Viterbi trellis construction based on branch metrics 845. Ordered path list 855 may be obtained by generating an LVA decoding trellis for L candidate paths for the N stages of the code word. The path metrics for each stage of the trellis may be based on accumulated path metrics (path metrics from ordered path metrics lists from feeding states of a previous stage and the branch metrics associated with the respective feeding transitions). Generating the LVA decoding trellis may include selecting an ordered path metrics list for each of the set of states for each of the N stages based on an iterative comparison, over the L candidate paths, of highest ranked unselected accumulated path metrics associated with respective feeding transitions to each of the set of states.

Outer decoder 840 may receive ordered path list 855 and run an error checking algorithm (e.g., CRC checking) on successive paths of the ordered path list 855 until a path that passes the error checking is found. Outer decoder 840 may then output the bitstream 865 corresponding to the path that passes the error checking to other components of the device 205 for further processing.

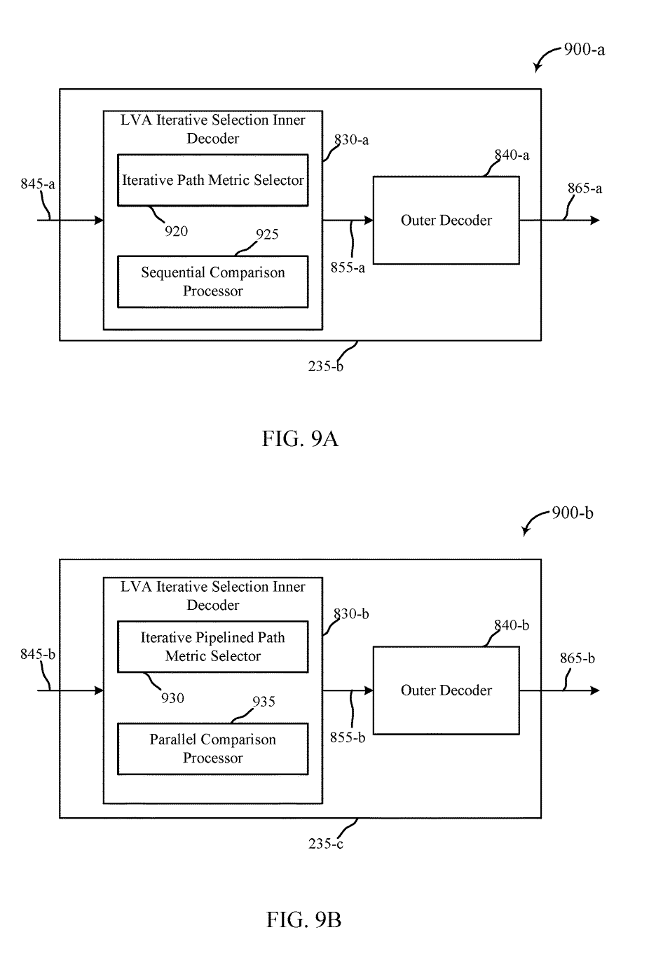

FIG. 9A shows a block diagram 900-a of a decoder that supports enhanced LVA decoding using iterative path selection in accordance with various aspects of the present disclosure. Decoder 235-b of FIG. 9A may be an example of aspects of decoders 235 of FIG. 2 or FIG. 8. Decoder 235-b may include LVA iterative selection inner decoder 830-a and outer decoder 840-a, which may be examples of LVA iterative selection inner decoder 830 and outer decoder 840 of FIG. 8. Decoder 235-b may also include a processor. Each of these components may be in communication with one another (e.g., via one or more buses).

LVA iterative selection inner decoder 830-a may receive branch metrics 845-a (e.g., from branch metrics identifier 815), and generate ordered path list 855-a, which may include, for example, the L best paths determined via Viterbi trellis construction based on branch metrics 845-a. LVA iterative selection inner decoder 830-a may include iterative path metrics selector 920 and sequential comparison processor 925. Sequential comparison processor 925 and iterative path metrics selector 920 may sequentially compute, for each stage of the N stages, the ordered path metrics list for each of the plurality of states as illustrated in FIGS. 6A-6D. For example, selection of the ordered path metrics lists for each stage may be performed in L sequential comparison cycles, where for each cycle sequential comparison processor 925 compares the highest ranked unselected accumulated path metrics associated with respective feeding transitions to each of the plurality of states and iterative path metrics selector 920 selects a next rank of the ordered path metrics list based on the comparison. Sequential comparison processor 925 may include, for example, a single comparator for each of the K states.

As discussed above, outer decoder 840-a may select output bits corresponding to one of the set of candidate paths for the data block by applying an error checking function to one or more of ordered path list 855-a and selecting a first candidate path that satisfies the error checking function. Outer decoder 840-a may then output the bitstream 865-a corresponding to the path that passes the error checking to other components of the device for further processing.

FIG. 9B shows a block diagram 900-b of a decoder that supports enhanced LVA decoding using iterative path selection in accordance with various aspects of the present disclosure. Decoder 235-c of FIG. 9B may be an example of aspects of decoders 235 of FIG. 2 or FIG. 8. Decoder 235-c may include LVA iterative selection inner decoder 830-b and outer decoder 840-b, which may be examples of LVA iterative selection inner decoder 830 and outer decoder 840 of FIG. 8. Decoder 235-c may also include a processor. Each of these components may be in communication with one another (e.g., via one or more buses).

LVA iterative selection inner decoder 830-b may receive branch metrics 845-b (e.g., from branch metrics identifier 815), and generate ordered path list 855-b, which may include, for example, the L best paths determined via Viterbi trellis construction based on branch metrics 845-b. LVA iterative selection inner decoder 830-b may include pipelined path metrics selector 930 and parallel comparison processor 935. Pipelined path metrics selector 930 and parallel comparison processor 935 may, for each of a set of pipelined trellis search cycles, concurrently compute, across a set of stages, sequentially decreasing ranks of respective ordered path metrics lists for the set of states of the trellis. In some cases, the concurrently computing includes: selecting, for each of the set of states, a first rank of the ordered path metrics list for a stage (n) of the N stages based on comparing highest ranked accumulated path metrics associated with the respective feeding transitions of a stage (n−1) and a second rank of the ordered path metrics list for the stage (n−1) of the N stages based on comparing highest ranked unselected accumulated path metrics for a stage (n−2). In some cases, the concurrently computing includes: selecting, for each of the set of states, an Lth rank of the ordered path metrics list for a stage (n−(L−1)) of the N stages based on comparing highest ranked unselected accumulated path metrics for a stage (n−L).

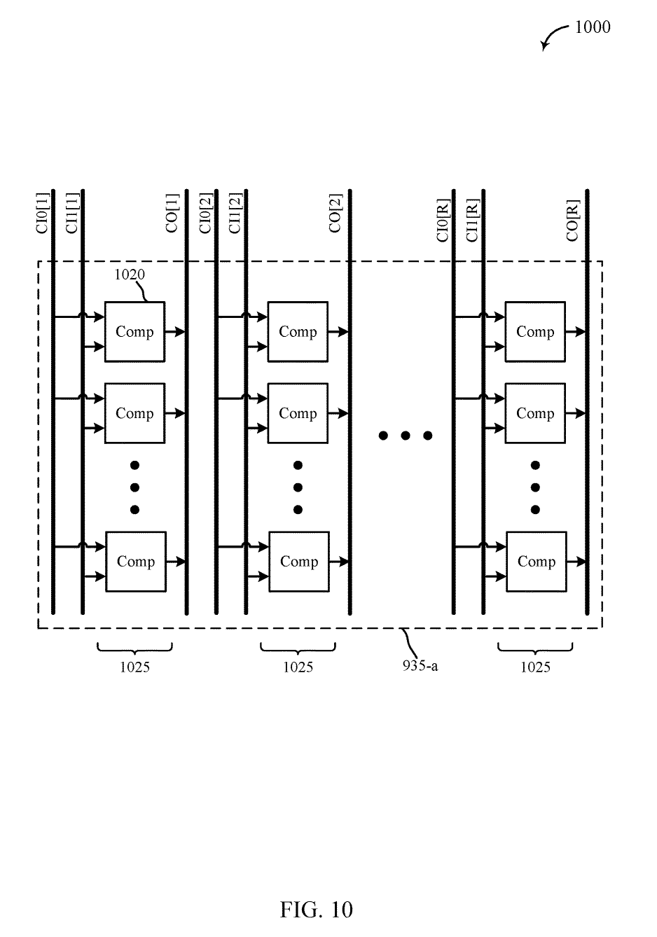

Parallel comparison processor 935 may include multiple comparators for each of the set of states. FIG. 10 shows a block diagram 1000 of a parallel comparison processor 935-a that supports enhanced LVA decoding using pipelined iterative path selection, in accordance with various aspects of the present disclosure. Parallel comparison processor 935-a may have multiple comparators 1020, which may be arranged according to comparator sets 1025. Each comparator set 1025 may have multiple comparator input (CI) busses (e.g., CI0, CI1) for receiving input accumulated path metrics values, and a comparator output (CO) bus that indicates results of the comparisons. Parallel comparison processor 935-a may have R comparators sets 1025, where each comparator set may have Q comparators. In some cases, R may be equal to the number of states in the trellis (e.g., R=K), and Q may be equal to the list size (e.g., Q=L). Thus, parallel comparison processor 935-a may be able to process L×K comparisons in a single cycle (e.g., logic cycle, processing cycle, or clock cycle).

In some examples, R sets of Q comparators may be used in different ways depending on the list size L and number of states K. For example, parallel comparison processor 935-a may have dimensions given by R=8 and Q=4. For decoding a first code word where K=4 and L=8, parallel comparison processor 935-a may process comparisons for each of the K states across each of L stages in a single comparison cycle. For decoding a second code word where K=8 and L=8, parallel comparison processor 935-a may be reconfigured to process each of the K states across L/2 stages in a single cycle. Thus, each pipelined trellis search cycle may take multiple comparison cycles. Thus, parallel comparison processor 935-a may have a given number (e.g., 32, 64, 128, etc.) of comparators 1020, which may be reconfigured for a given number of states K and list size L in an LVA decoding operation.

Returning to FIG. 9B, outer decoder 840-b may select output bits corresponding to one of the set of candidate paths for the data block by applying an error checking function to one or more of ordered path list 855-b and selecting a first candidate path that satisfies the error checking function. Outer decoder 840-b may then output the bitstream 865-b corresponding to the path that passes the error checking to other components of the device for further processing.

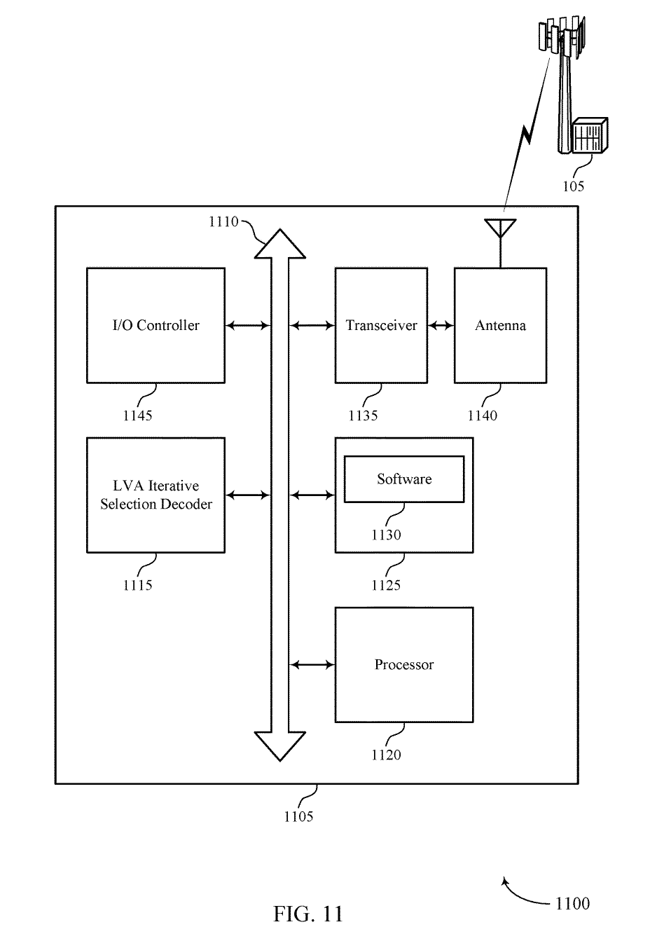

FIG. 11 shows a diagram of a system 1100 including a device 1105 that supports enhanced LVA decoding using iterative path selection in accordance with various aspects of the present disclosure. Device 1105 may be an example of or include the components of wireless device 805 or a UE 115 as described above, e.g., with reference to FIGS. 1, 8 and 9.

Device 1105 may include components for bi-directional voice and data communications including components for transmitting and receiving communications, including processor 1120, memory 1125, software 1130, transceiver 1135, antenna 1140, I/O controller 1145, and LVA iterative selection decoder 1115. Each of these components may be connected to any of the other components (e.g., via one or more buses 1110).

Processor 1120 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting enhanced LVA decoding using iterative path selection).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a Basic Input-Output system (BIOS) which may control basic hardware and/or software operation such as the interaction with peripheral components or devices.

Software 1130 may include code to implement aspects of the present disclosure, including code to support enhanced LVA decoding using iterative path selection. Software 1130 may be stored in a non-transitory computer-readable medium such as system memory or other memory. In some cases, the software 1130 may not be directly executable by the processor but may cause a computer (e.g., when compiled and executed) to perform functions described herein. In some cases, software 1130 may include an operating system such as iOS®, ANDROID®, MS-DOS®, MS-WINDOWS®, OS/2®, UNIX®, LINUX®, or another commercially available or custom operating system.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. Input/output control component 1145 may also manage peripherals not integrated into device 1105. In some cases, input/output control component 1145 may represent a physical connection or port to an external peripheral.

LVA iterative selection decoder 1115 may receive branch metrics (e.g., from transceiver 1135), and output a decoded bit stream and/or error information. LVA iterative selection decoder 1115 may include an iterative selection inner decoder (e.g., LVA iterative selection inner decoder 830 of FIG. 8, 9A or 9B) that may generate an ordered path metrics list using the discussed iterative selection techniques. The ordered path metrics list may include, for example, the L best paths determined via Viterbi trellis construction based on the branch metrics using iterative selection. LVA iterative selection decoder 1115 may perform sequential iterative selection, or pipelined iterative selection, as discussed above. LVA iterative selection decoder 1115 may include an outer decoder (e.g., outer decoder 840 of FIG. 8, 9A or 9B) for performing an error checking function and outputting a bit stream corresponding to the highest ranking path that satisfies the error checking function.

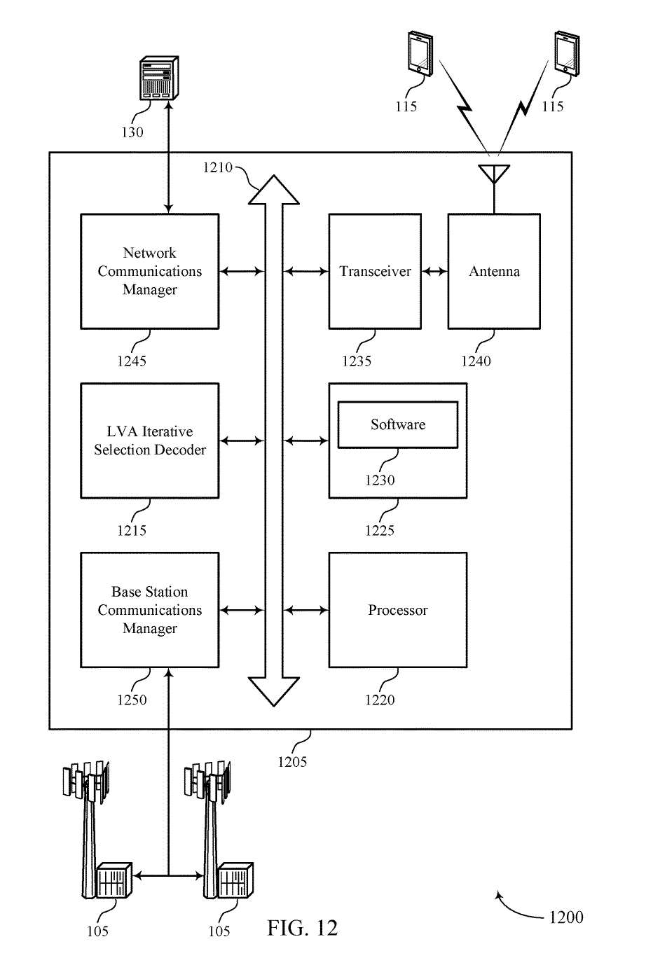

FIG. 12 shows a diagram of a system 1200 including a device 1205 that supports enhanced LVA decoding using iterative path selection in accordance with various aspects of the present disclosure. Device 1205 may be an example of or include the components of wireless device 805 or a base station 105 as described above, e.g., with reference to FIGS. 1, 8 and 9.

Device 1205 may include components for bi-directional voice and data communications including components for transmitting and receiving communications, including, processor 1220, memory 1225, software 1230, transceiver 1235, antenna 1240, network communications manager 1245, base station communications manager 1250, and LVA iterative selection decoder 1215. Each of these components may be connected to any of the other components (e.g., via one or more buses 1210).

Processor 1220 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting enhanced LVA decoding using iterative path selection).1220.

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a Basic Input-Output system (BIOS) which may control basic hardware and/or software operation such as the interaction with peripheral components or devices.

Software 1230 may include code to implement aspects of the present disclosure, including code to support enhanced LVA decoding using iterative path selection. Software 1230 may be stored in a non-transitory computer-readable medium such as system memory or other memory. In some cases, the software 1230 may not be directly executable by the processor but may cause a computer (e.g., when compiled and executed) to perform functions described herein. In some cases, software 1230 may include an operating system such as iOS®, ANDROID®, MS-DOS®, MS-WINDOWS®, OS/2®, UNIX®, LINUX®, or another commercially available or custom operating system.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

Network communications manager 1245 may manage communications with the core network (e.g., via one or more wired backhaul links). For example, the network communications module 1245 may manage the transfer of data communications for client devices, such as one or more UEs 115.

Base station communications manager 1250 may manage communications with other base station 105, and may include a controller or scheduler for controlling communications with UEs 115 in cooperation with other base stations 105. For example, the base station communications manager 1250 may coordinate scheduling for transmissions to UEs 115 for various interference mitigation techniques such as beamforming or joint transmission. In some examples, base station communications manager 1250 may provide an X2 interface within an LTE/LTE-A wireless communication network technology to provide communication between base stations 105.

LVA iterative selection decoder 1215 may receive branch metrics (e.g., from transceiver 1235), and output a decoded bit stream and/or error information. LVA iterative selection decoder 1215 may include an iterative selection inner decoder (e.g., LVA iterative selection inner decoder 830 of FIG. 8, 9A or 9B) that may generate an ordered path metrics list using the discussed iterative selection techniques. The ordered path metrics list may include, for example, the L best paths determined via Viterbi trellis construction based on the branch metrics using iterative selection. LVA iterative selection decoder 1215 may perform sequential iterative selection, or pipelined iterative selection, as discussed above. LVA iterative selection decoder 1215 may include an outer decoder (e.g., outer decoder 840 of FIG. 8, 9A or 9B) for performing an error checking function and outputting a bit stream corresponding to the highest ranking path that satisfies the error checking function.

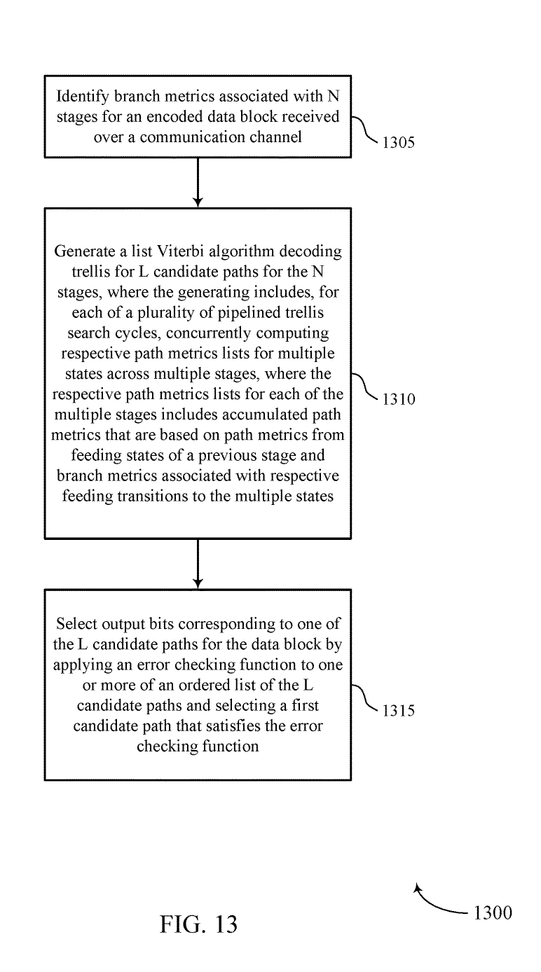

FIG. 13 shows a flowchart illustrating a method 1300 for enhanced LVA decoding using iterative path selection in accordance with various aspects of the present disclosure. The operations of method 1300 may be implemented by a UE 115 or base station 105 or its components as described herein. For example, the operations of method 1300 may be performed by a LVA iterative selection decoder as described with reference to FIG. 11 or 12. In some examples, a UE 115 or base station 105 may execute a set of codes to control the functional elements of the device to perform the functions described below. Additionally or alternatively, the UE 115 or base station 105 may perform aspects the functions described below using special-purpose hardware.

At block 1305, the UE 115 or base station 105 may identify branch metrics associated with N stages for an encoded data block received over a communication channel. The operations of block 1305 may be performed according to the methods described with reference to FIG. 2 or 8. In certain examples, aspects of the operations of block 1305 may be performed by a branch metrics identifier 815 as described with reference to FIG. 8.

At block 1310, the UE 115 or base station 105 may generate a list Viterbi algorithm decoding trellis for L candidate paths for the N stages, where the generating includes, for each of a plurality of pipelined trellis search cycles, concurrently computing respective path metrics lists for multiple states across multiple stages, where the respective path metrics lists for each of the multiple stages includes accumulated path metrics that are based on path metrics from feeding states of a previous stage and branch metrics associated with respective feeding transitions to the multiple states. The operations of block 1310 may be performed according to the methods described with reference to FIG. 6A-6D or 7A-7F. In certain examples, aspects of the operations of block 1310 may be performed by an LVA iterative selection inner decoder as described with reference to FIGS. 8 through 10.

At block 1315, the UE 115 or base station 105 may select output bits corresponding to one of the L candidate paths for the data block by applying an error checking function to one or more of an ordered list of the L candidate paths and selecting a first candidate path that satisfies the error checking function. The operations of block 1315 may be performed according to the methods described with reference to FIG. 2 or 8. In certain examples, aspects of the operations of block 1315 may be performed by an outer decoder 225 or 840 as described with reference to FIG. 2, 8, 9A or 9B.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (WiFi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying branch metrics associated with N stages for an encoded data block received over a communication channel;
generating a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states; and
selecting output bits corresponding to one of the L candidate paths for the data block by applying an error checking function to one or more of an ordered list of the L candidate paths and selecting a first candidate path that satisfies the error checking function.

2. The method of claim 1, wherein the generating comprises ordering the respective path metrics lists for the plurality of states for each of the N stages based on an iterative comparison, over the L candidate paths, of highest ranked unselected metrics of the accumulated path metrics for the each of the N stages.

3. The method of claim 2, wherein ordering the respective path metrics lists for the plurality of states for each of the N stages based on the iterative comparison comprises:
comparing highest ranked unselected accumulated path metrics associated with respective feeding transitions to each of the plurality of states;
selecting a next rank of the ordered path metrics list based on the comparison; and
iteratively performing the comparing and selecting over the L candidate paths.

4. The method of claim 1, wherein the concurrently computing comprises selecting, for each of the plurality of states, a first rank of the ordered path metrics list for a stage (n) of the N stages based on comparing highest ranked accumulated path metrics associated with the respective feeding transitions of a stage (n−1) and a second rank of the ordered path metrics list for the stage (n−1) of the N stages based on comparing highest ranked unselected accumulated path metrics for a stage (n−2).

5. The method of claim 4, wherein the concurrently computing comprises selecting, for each of the plurality of states, an Lth rank of the ordered path metrics list for a stage (n−(L−1)) of the N stages based on comparing highest ranked unselected accumulated path metrics for a stage (n−L).

6. The method of claim 1, wherein the concurrently computing, for each of the plurality of pipelined trellis search cycles, is performed with a plurality of comparators for each of the plurality of states.

7. The method of claim 6, wherein the plurality of comparators includes L comparators for each of the plurality of states.

8. The method of claim 1, wherein the generating comprises sequentially computing, for each stage of the N stages, the ordered path metrics list for each of the plurality of states.

9. The method of claim 8, wherein the comparisons for the sequential computing for each of the plurality of states are performed with a single comparator.

10. The method of claim 1, wherein the encoded data block is encoded according to a convolutional code.

11. An apparatus for wireless communication, comprising:
means for identifying branch metrics associated with N stages for an encoded data block received over a communication channel;
means for generating a list Viterbi algorithm decoding trellis for L candidate paths for the N stages, comprising:
means for concurrently computing, for each of a plurality of pipelined trellis search cycles, respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states; and
means for selecting output bits corresponding to one of the L candidate paths for the data block by applying an error checking function to one or more of an ordered list of the L candidate paths and selecting a first candidate path that satisfies the error checking function.

12. The apparatus of claim 11, wherein the means for generating comprises means for ordering the respective path metrics lists for the plurality of states for each of the N stages based on an iterative comparison, over the L candidate paths, of highest ranked unselected metrics of the accumulated path metrics for the each of the N stages.

13. The apparatus of claim 12, wherein the means for ordering the respective path metrics list for the plurality of states for each of the N stages based on the iterative comparison compares highest ranked unselected accumulated path metrics associated with respective feeding transitions to each of the plurality of states, selects a next rank of the ordered path metrics list based on the comparison, and iteratively performs the comparing and selecting over the L candidate paths.

14. The apparatus of claim 11, wherein the means for concurrently computing selects, for each of the plurality of states, a first rank of the ordered path metrics list for a stage (n) of the N stages based on comparing highest ranked accumulated path metrics associated with the respective feeding transitions of a stage (n−1) and a second rank of the ordered path metrics list for the stage (n−1) of the N stages based on comparing highest ranked unselected accumulated path metrics for a stage (n−2).

15. The apparatus of claim 14, wherein the means for concurrently computing selects, for each of the plurality of states, an Lth rank of the ordered path metrics list for a stage (n−(L−1)) of the N stages based on comparing highest ranked unselected accumulated path metrics for a stage (n−L).

16. The apparatus of claim 11, wherein the means for generating comprises means for sequentially computing, for each stage of the N stages, the ordered path metrics list for each of the plurality of states.

17. The apparatus of claim 11, wherein the encoded data block is encoded according to a convolutional code.

18. An apparatus for wireless communication, comprising:
a processor;
memory in electronic communication with the processor; and
instructions stored in the memory and operable, when executed by the processor, to cause the apparatus to:
identify branch metrics associated with N stages for an encoded data block received over a communication channel;
generate a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states; and
select output bits corresponding to one of the L candidate paths for the data block by applying an error checking function to one or more of an ordered list of the L candidate paths and selecting a first candidate path that satisfies the error checking function.

19. The apparatus of claim 18, wherein the instructions for generating the list Viterbi algorithm decoding trellis comprise instructions for ordering the respective path metrics lists for the plurality of states for each of the N stages based on an iterative comparison, over the L candidate paths, of highest ranked unselected metrics of the accumulated path metrics for the each of the N stages.

20. The apparatus of claim 19, wherein the instructions for selecting the ordered path metrics list for each of the plurality of states for each of the N stages based on the iterative comparison comprise instructions for:
comparing highest ranked unselected accumulated path metrics associated with respective feeding transitions to each of the plurality of states;
select a next rank of the ordered path metrics list based on the comparison; and
iteratively perform the comparing and selecting over the L candidate paths

21. The apparatus of claim 18, wherein the concurrently computing comprises selecting, for each of the plurality of states, a first rank of the ordered path metrics list for a stage (n) of the N stages based on comparing highest ranked accumulated path metrics associated with the respective feeding transitions of a stage (n−1) and a second rank of the ordered path metrics list for the stage (n−1) of the N stages based on comparing highest ranked unselected accumulated path metrics for a stage (n−2).

22. The apparatus of claim 21, wherein the concurrently computing comprises selecting, for each of the plurality of states, an Lth rank of the ordered path metrics list for a stage (n−(L−1)) of the N stages based on comparing highest ranked unselected accumulated path metrics for a stage (n−L).

23. The apparatus of claim 18, wherein the concurrently computing, for each of the plurality of pipelined trellis search cycles is performed with a plurality of comparators for each of the plurality of states.

24. The apparatus of claim 23, wherein the plurality of comparators includes L comparators for each of the plurality of states.

25. The apparatus of claim 18, wherein the instructions for generating comprise instructions for sequentially computing, for each stage of the N stages, the ordered path metrics list for each of the plurality of states.

26. The apparatus of claim 25, wherein the comparisons for the sequential computing for each of the plurality of states are performed with a single comparator.

27. The apparatus of claim 18, wherein the encoded data block is encoded according to a convolutional code.

28. A non-transitory computer readable medium storing code for wireless communication, the code comprising instructions executable by a processor to:
identify branch metrics associated with N stages for an encoded data block received over a communication channel;
generate a list Viterbi algorithm decoding trellis for L candidate paths for the N stages, wherein the generating comprises, for each of a plurality of pipelined trellis search cycles, concurrently computing respective path metrics lists for a plurality of states across a plurality of stages, wherein the respective path metrics lists for each of the plurality of stages comprise accumulated path metrics that are based on path metrics from feeding states of a previous stage and branch metrics associated with respective feeding transitions to the plurality of states; and
select output bits corresponding to one of the L candidate paths for the data block by applying an error checking function to one or more of an ordered list of the L candidate paths and selecting a first candidate path that satisfies the error checking function.
